(19) United States
(12) Patent Application Publication
(10) Pub. No.: US 2026/0310036 A1
(43) Pub. Date: Oct. 8, 2026

(54) DISPLAY DEVICE

(71) Applicant: E Ink Holdings Inc., HSINCHU (TW)

(72) Inventors: Po-Yuan LO, HSINCHU (TW); Xian-Teng CHUNG, HSINCHU (TW); Liang-Yu LIN, HSINCHU (TW); Ian FRENCH, HSINCHU (TW)

(21) Appl. No.: 19/440,681

(22) Filed: Jan. 6, 2026

(30) Foreign Application Priority Data
Apr. 2, 2025 (TW) 114112875

(51) Int. Cl. G02F 1/1677; G02F 1/167

(52) U.S. Cl. CPC G02F 1/1677; G02F 1/167

(57) ABSTRACT

A display device includes a first substrate, a color filter conductive structure, a display medium, a second substrate and a common electrode. The second substrate is disposed opposite to the first substrate. The display medium is disposed on the first substrate. The common electrode is disposed on the second substrate. The color filter conductive structure is disposed between the display medium and the common electrode, and is electrically connected to the common electrode.

This application claims priority to Taiwan Application Serial Number 114112875, filed April 2, 2025, which is herein incorporated by reference in its entirety.

### BACKGROUND

### Field of Invention

The present disclosure relates to a display device. More particularly, the present disclosure relates to a display device including a color filter conductive structure.

### Description of Related Art

Color display devices display full-color image by making light pass through color filter patterns. However, conventional color filter patterns have relatively high sheet resistance, and when placed between pixel electrodes and common electrode, they cause a decrease in the electric field strength driving the display medium, resulting in poor optical performance, such as low contrast, which in turn affects the display quality of color display devices.

### SUMMARY

At least one embodiment of the present disclosure provides a display device including a color filter conductive structure electrically connected to the common electrode. The color filter conductive structure can maintain the electric field strength driving the display medium, thereby preventing poor optical performance caused by a decrease in electric field strength, such as low contrast, which would affect the display quality of the display device.

The display device according to at least one embodiment of the present disclosure includes a first substrate, a color filter conductive structure, a display medium, second substrate and a common electrode. The second substrate is disposed opposite the first substrate. The display medium is disposed on the first substrate. The common electrode is disposed on the second substrate. The color filter conductive structure is disposed between the display medium and the common electrode, and is electrically connected to the common electrode.

The display device according to at least another embodiment of the present disclosure includes a first substrate, a display medium, a color filter conductive structure, a common electrode and a second substrate. The display medium, the color filter conductive structure, the common electrode and the second substrate are sequentially disposed on the first substrate, and the color filter conductive structure is electrically connected to the common electrode.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic top view of a display device according to at least one embodiment of the present disclosure.

FIG. 2 is a partial schematic cross-sectional view of a display area of a display device according to at least one embodiment of the present disclosure.

FIG. 3 is a partial schematic cross-sectional view of a display area of a display device according to at least another embodiment of the present disclosure.

FIG. 4 is a partial schematic cross-sectional view of a display area of a display device according to at least another embodiment of the present disclosure.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

Furthermore, the words "about", "approximately" or "substantially" used in the present disclosure not only cover the clearly stated numerical values and numerical ranges, but also cover those that can be understood by a person with ordinary knowledge in the technical field to which the present disclosure belongs. The permissible deviation range can be determined by the error generated during measurement, and the error is caused, for example, by limitations of the measurement system or process conditions. In addition, "about" may mean within one or more standard deviations of the above values, such as within ±30%, ±20%, ±10%, or ±5%. Such words as "about", "approximately", or "substantially" as appearing in the present disclosure may be used to select an acceptable range of deviation or standard deviation according to optical properties, etching properties, mechanical properties, or other properties, rather than applying all of the above optical properties, etching properties, mechanical properties, and other properties with a single standard deviation.

The spatial relative terms used in the present disclosure, such as "below," "under," "above," "on," and the like, are intended to facilitate the recitation of a relative relationship between one element or feature and another as depicted in the drawings. The true meaning of these spatial relative terms includes other orientations. For example, the relationship between one element and another may change from "below" and "under" to "above" and "on" when the drawing is turned 180 degrees up or down. In addition, spatially relative descriptions used in the present disclosure should be interpreted in the same manner.

It should be understood that while the present disclosure may use terms such as "first", "second", "third" to describe various elements or features, these elements or features should not be limited by these terms. These terms are primarily used to distinguish one element from another or one feature from another. In addition, the term "or" as used in the present disclosure may include, as appropriate, any one or a combination of the listed items in association.

Moreover, the present disclosure may be implemented or applied in various other specific embodiments, and the details of the present disclosure may be combined, modified, and altered in various embodiments based on different viewpoints and applications, without departing from the idea of the present disclosure.

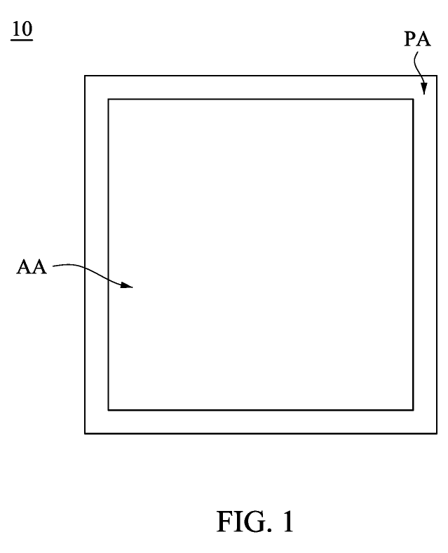

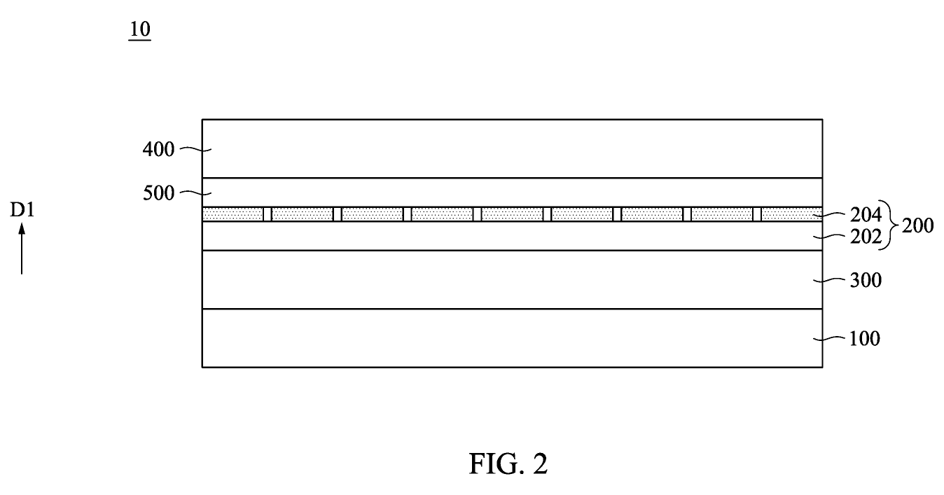

FIG. 1 is a schematic top view of a display device 10 according to at least one embodiment of the present disclosure. FIG. 2 is a partial schematic cross-sectional view of a display area AA of a display device 10 according to at least one embodiment of the present disclosure. Referring to FIGS. 1 and 2, the display device 10 has a display area AA and a peripheral area PA adjacent to the display area AA. The display device 10 includes a first substrate 100, a color filter conductive structure 200, a display medium 300, a second substrate 400, and a common electrode 500. The display medium 300, the color filter conductive structure 200, the common electrode 500, and the second substrate 400 are arranged in the normal line of the first substrate 100 (i.e., a first direction D1).

In detail, the display medium 300 is disposed on the first substrate 100. The color filter conductive structure 200 is disposed on the display medium 300. The common electrode 500 is disposed on the color filter conductive structure 200. The second substrate 400 is disposed on the common electrode 500, and the common electrode 500 is electrically connected to the color filter conductive structure 200. The stacked structure of the display device 10 shown in FIG. 2 can be manufactured by combining various embodiments depending on practical needs. In one embodiment, the display medium 300 is formed on the first substrate 100, and then the color filter conductive structure 200 is formed on the display medium 300. The common electrode 500 is formed on the second substrate 400, and then the second substrate 400 is disposed opposite to the first substrate 100 and bonded to the first substrate 100. In another embodiment, the display medium 300 may be formed on the first substrate 100. The common electrode 500 may be formed on the second substrate 400, and then the color filter conductive structure 200 may be formed on the common electrode 500. Next, the second substrate 400 and the first substrate 100 may be disposed opposite to each other and bonded together. The manufacturing methods are not limited to this. Since the color filter conductive structure 200 is electrically connected to the common electrode 500, the electric field strength driving the display medium 300 can be maintained, preventing poor optical performance, such as low contrast, due to a decrease in electric field strength, which would affect the display quality of the display device 10.

For example, the contrast ratio of a color display device including conventional color filter patterns with a high sheet resistance disposed between the pixel electrodes and the common electrode decreases by approximately 26% to 31% compared to the contrast ratio of a black-and-white display device not including the conventional color filter patterns. The contrast ratio of the display device 10 according to the embodiment of the present disclosure decreases by approximately 22% to 27% compared to the contrast ratio of the aforementioned black-and-white display device. Therefore, the present disclosure can effectively reduce the decrease in contrast ratio by making the color filter conductive structure 200 be electrically connected to the common electrode 500, thereby improving display quality.

Referring to FIG. 2, the color filter conductive structure 200 includes a conductive layer 202 and multiple color filter patterns 204. The conductive layer 202 is disposed on the display medium 300 and is electrically connected to the common electrode 500. The color filter patterns 204 may be formed on the conductive layer 202 or formed on the common electrode 500, and are located between the conductive layer 202 and the common electrode 500.

In some embodiments, the conductive layer 202 may include a transparent conductive layer. The transparent conductive layer may include a transparent conductive material such as conductive polymer, indium tin oxide, zinc oxide, indium zinc oxide, carbon nanotubes, silver nanotubes, or any combination thereof. The conductive layer 202 may be directly in contact with the common electrode 500 to be electrically connected to the common electrode 500, or the conductive layer 202 may be electrically connected to the common electrode 500 via a conductive adhesive (not shown).

It is worth noting that in order to simplify the expression of the figure, FIG. 2 merely shows nine color filter patterns 204 as a representative representation. However, it can be understood that other color filter patterns 204 may also be included where not shown on the page of the figure. In some embodiments, the colors of the color filter patterns 204 may be red, green, and blue, respectively. The material of the color filter patterns 204 may include color resist.

In some embodiments, the first substrate 100 and the second substrate 400 may be, for example, a glass substrate, a plastic substrate, a silicon substrate, a flexible substrate, or other suitable substrate. The first substrate 100 may be an array substrate, which may include, for example, multiple pixel electrodes (not shown), multiple switching elements (not shown, such as transistors) electrically connected to the pixel electrodes respectively, or other electronic elements (not shown, such as capacitors). The pixel electrodes may correspond to the color filter patterns 204 respectively. In detail, in the normal line of the first substrate 100 (i.e., the first direction D1), the pixel electrodes overlap the color filter patterns 204 respectively.

In some embodiments, the material of the common electrode 500 and the material of the pixel electrodes may include an opaque conductive material, a transparent conductive material, or any combination thereof. The opaque conductive material may be a metal, such as molybdenum, or a metal compound, such as molybdenum nitride or molybdenum niobium. The transparent conductive material may be, for example, indium tin oxide or indium zinc oxide.

In some embodiments, the sheet resistance of the conductive layer 202 is less than 1 MΩ/□, and the sheet resistance of the color filter patterns 204 is not less than 1 GΩ/□. That is, the sheet resistance of the conductive layer 202 is approximately in the order of KΩ/□, and the sheet resistance of the color filter patterns 204 is approximately in the order of GΩ/□. Although the sheet resistance of the color filter patterns 204 is still relatively high, since the color filter patterns 204 are located between the conductive layer 202, which has a lower sheet resistance, and the common electrode 500, and the conductive layer 202 is electrically connected to the common electrode 500, even if the sheet resistance of the color filter patterns 204 is relatively high, it does not easily cause a decrease in the electric field strength driving the display medium 300. Therefore, poor optical performance due to the decrease in electric field strength, such as low contrast, which affects the display quality of the display device 10, can be avoided.

In some embodiments, the display medium 300 may be an electrophoretic display layer, but the present disclosure is not limited thereto. In other embodiments, the display medium 300 may be a liquid crystal display layer, an electrowetting display layer, a liquid powder display layer, or other suitable display layer.

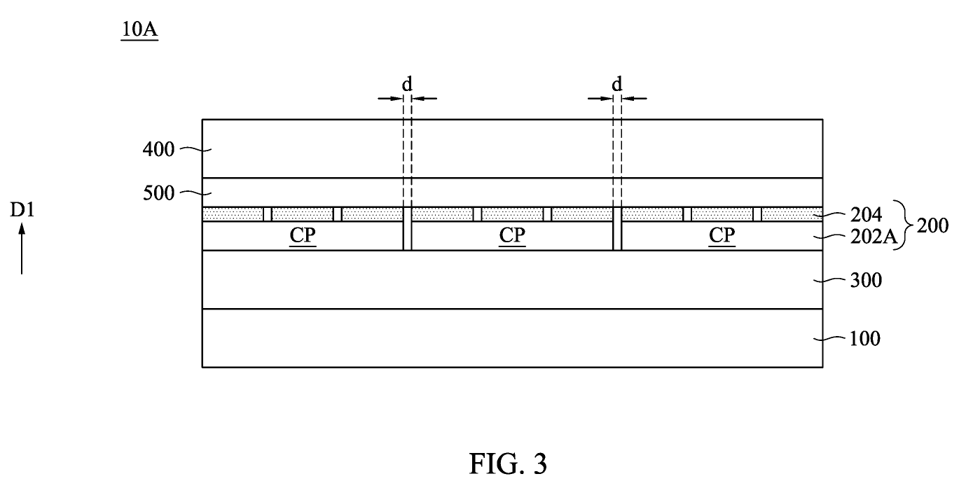

FIG. 3 is a partial schematic cross-sectional view of a display area AA of a display device 10A according to at least another embodiment of the present disclosure. Referring to FIG. 3, the structures, the materials and the relative positions of most elements in the embodiment of FIG. 3 and the embodiment of FIG. 2 are the same, and the schematic top view of the display device 10A of FIG. 3 is substantially the same as the schematic top view of the display device 10 of FIG. 2, so the same features are not repeated here. The main difference between the two embodiments is that the conductive layer 202A of the display device 10A includes multiple conductive patterns CP separated from each other. Gaps d exist between the conductive patterns CP, and the gaps d separate the conductive patterns CP from each other. In some embodiments, the conductive patterns CP may serve as touch electrodes, but the present disclosure is not limited thereto.

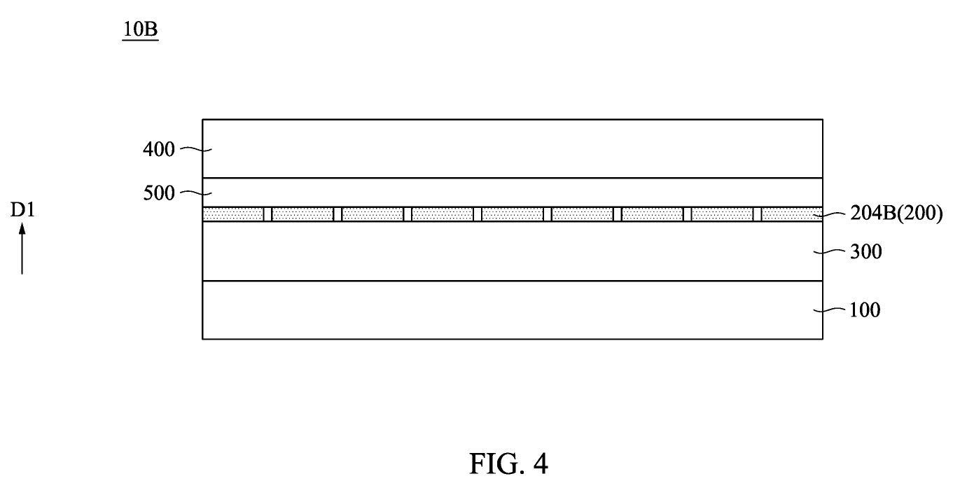

FIG. 4 is a partial schematic cross-sectional view of a display area AA of a display device 10B according to at least another embodiment of the present disclosure. Referring to FIG. 4, the structures, the materials and the relative positions of most elements in the embodiment of FIG. 4 and the embodiment of FIG. 2 are the same, and the schematic top view of the display device 10B of FIG. 4 is substantially the same as the schematic top view of the display device 10 of FIG. 2, so the same features are not repeated here. The main difference between the two embodiments is that the color filter conductive structure 200 of the display device 10B includes multiple color filter conductive patterns 204B.

In detail, the color filter conductive patterns 204B may be formed on the display medium 300 or formed on the common electrode 500, and are directly in contact with the common electrode 500 to be electrically connected to the common electrode 500. Similarly, the pixel electrodes of the first substrate 100 may correspond to the color filter conductive patterns 204B respectively. That is, in the normal line of the first substrate 100 (i.e., the first direction D1), the pixel electrodes overlap the color filter conductive patterns 204B respectively.

In some embodiments, the material of the color filter conductive patterns 204B may include dyes and conductive polymer, carbon nanotubes, silver nanoparticles, or a mixture of thereof. The sheet resistance of the color filter conductive patterns 204B is less than 1 MΩ/□, that is, the sheet resistance of the color filter conductive patterns 204B is approximately in the order of KΩ/□. Since the color filter conductive patterns 204B have a low sheet resistance and are electrically connected to the common electrode 500, even if the color filter conductive patterns 204B are disposed between the pixel electrodes and the common electrode 500, it does not easily cause a decrease in the electric field strength driving the display medium 300. Therefore, poor optical performance due to the decrease in electric field strength, such as low contrast, which affects the display quality of the display device 10B, can be avoided.

In summary, in at least one embodiment of the display device of the present disclosure, the color filter conductive structure is electrically connected to the common electrode, thereby maintaining the electric field strength driving the display medium, avoiding the situation where the electric field strength decreases and causes poor optical performance, such as low contrast, which affects the display quality of the display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A display device, comprising:
a first substrate;
a display medium, disposed on the first substrate;
a second substrate, disposed opposite to the first substrate;
a common electrode, disposed on the second substrate; and
a color filter conductive structure, disposed between the display medium and the common electrode, and electrically connected to the common electrode.

2. The display device of claim 1, wherein the color filter conductive structure comprises:
a conductive layer, disposed on the display medium, and electrically connected to the common electrode; and
a plurality of color filter patterns, formed on the conductive layer, and located between the conductive layer and the common electrode.

3. The display device of claim 2, wherein the conductive layer comprises a transparent conductive layer.

4. The display device of claim 3, wherein a material of the transparent conductive layer comprises conductive polymer, indium tin oxide, zinc oxide, indium zinc oxide, carbon nanotubes, silver nanoparticles or any combination thereof.

5. The display device of claim 2, wherein the first substrate comprises a plurality of pixel electrodes corresponding to the color filter patterns respectively.

6. The display device of claim 2, wherein a sheet resistance of the conductive layer is less than 1 MΩ/□.

7. The display device of claim 6, wherein the sheet resistance of the conductive layer is in an order of KΩ/□.

8. The display device of claim 2, wherein a sheet resistance of the color filter patterns is not less than 1 GΩ/□.

9. The display device of claim 8, wherein the sheet resistance of the color filter patterns is in an order of GΩ/□.

10. The display device of claim 2, wherein the conductive layer comprises a plurality of conductive patterns separated from each other.

11. The display device of claim 10, wherein the conductive patterns serve as touch electrodes.

12. The display device of claim 1, wherein the color filter conductive structure comprises a plurality of color filter conductive patterns directly in contact with the common electrode to be electrically connected to the common electrode.

13. The display device of claim 12, wherein a sheet resistance of the color filter conductive patterns is not less than 1 MΩ/□.

14. The display device of claim 13, wherein the sheet resistance of the color filter conductive patterns is in an order of KΩ/□.

15. A display device, comprising:
a first substrate;
a display medium;
a color filter conductive structure;
a common electrode; and
a second substrate, wherein the display medium, the color filter conductive structure, the common electrode and the second substrate are sequentially disposed on the first substrate, wherein the color filter conductive structure is electrically connected to the common electrode.

16. The display device of claim 15, wherein the color filter conductive structure comprises:
a conductive layer, disposed on the display medium, and electrically connected to the common electrode; and
a plurality of color filter patterns, disposed between the conductive layer and the common electrode.

17. The display device of claim 16, wherein a sheet resistance of the conductive layer is less than 1 MΩ/□.

18. The display device of claim 16, wherein a sheet resistance of the color filter patterns is not less than 1 GΩ/□.

19. The display device of claim 15, wherein the color filter conductive structure comprises a plurality of color filter conductive patterns directly in contact with the common electrode to be electrically connected to the common electrode.

20. The display device of claim 19, wherein a sheet resistance of the color filter conductive patterns is not less than 1 MΩ/□.
